(19) United States
(12) Patent Application Publication
(10) Pub. No.: US 2025/0074142 A1
(43) Pub. Date: Mar. 6, 2025

(54) VEHICLE AIR CONDITIONING SYSTEM

(71) Applicant: NGK INSULATORS, LTD., Nagoya-City (JP)

(72) Inventor: Yoshiki KONNO, Tajimi-Shi (JP)

(73) Assignee: NGK INSULATORS, LTD., Nagoya-City (JP)

(21) Appl. No.: 18/796,376

(22) Filed: Aug. 7, 2024

(30) Foreign Application Priority Data
Aug. 30, 2023 (JP) 2023-140430

(51) Int. Cl. B60H 1/00

(52) U.S. Cl. CPC B60H 1/00564

(57) ABSTRACT

A vehicle air conditioning system includes: an air conditioning duct for allowing air from a vehicle interior to flow therethrough; and an air conditioning device disposed within the air conditioning duct. The air conditioning device includes: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; and a cooling member disposed over the outer peripheral wall of the honeycomb structure, the cooling member forming a flow path between the honeycomb structure and the cooling member, the flow path allowing a refrigerant to flow therethrough.

### CROSS REFERENCE TO RELATED APPLICATIONS

The present invention claims the benefit of priority to Japanese Patent Application No 2023-140430 filed on Aug. 30, 2023 with the Japanese Patent Office, the entire contents of which are incorporated herein by reference in its entirety.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Specific requirements include reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problem, Patent Literatures 1 and 2 disclose a vehicle air conditioning system in which components to be removed such as moisture (water vapor) and CO₂ in the air in the vehicle interior are trapped by a functional material such as an adsorbent, and the components to be removed are then reacted or desorbed by heating to discharge them to the vehicle exterior and regenerate the functional material. Such a vehicle air conditioning system requires more contact between the air and the functional material in order to ensure the performance of trapping the components to be removed, and the ability of the functional material to be heated to a predetermined temperature in order to facilitate the regeneration of the functional material. The regeneration can be carried out, for example, by removing the components to be removed, which are adsorbed on the functional material, through an oxidation reaction, and by desorbing and releasing the components to be removed, adsorbed on the functional material, but both cases require the heating of the functional material at an appropriate temperature depending on the type of the adsorbed components to be removed.

Patent Literature 3 discloses a heater element, including: a pillar shaped honeycomb structure having an outer peripheral wall and partition walls disposed on an inner side of the outer peripheral wall and defining a plurality of cells forming flow paths from a first end face to a second end face, wherein the partition walls have a PTC property, the partition walls have an average thickness of 0.13 mm or less, and the first end face and the second end face have an opening ratio of 0.81 or more. This heater element is used for heating a vehicle interior, and is an efficient heating means because the honeycomb structure allows the heating area to be increased. Therefore, the use of such a heater element as a support for the functional material can contribute to the shortening of the regeneration time of the functional material. In particular, it is believed that since this heater element can be heated by electric conduction and has a PTC property, it can easily heat the functional material, while suppressing excessive heat generation and thermal deterioration of the functional material. Further, since the risk of excessive temperature is avoided, safety can be ensured even if small initial resistance is set to increase a heating rate, and the temperature can be increased in a short period of time.

On the other hand, an air conditioning system using a heat pump cycle has been proposed from the viewpoint of improving a vehicle heating efficiency (e.g., Patent Literature 4). In the air conditioning system using the heat pump cycle, the air is cooled and dehumidified by an evaporator that forms the heat pump cycle during dehumidification and cooling operation modes. However, the evaporator is prone to condensation, which causes mold to be generated on the evaporator when dust and the like adhere to it. When the air is in contact with the evaporator in such a state, the vehicle interior may be damaged, and allergic symptoms may be caused in the driver. Also, the condensation on the evaporator increases ventilation resistance.

The present invention was made to solve the problems as described above. An object of the present invention is to provide a vehicle air conditioning system that can perform dehumidification and cooling operations without using an evaporator.

### PRIOR ART

### Patent Literatures

[Patent Literature 1] Japanese Patent Application Publication No. 2020-104774 A
[Patent Literature 2] Japanese Patent Application Publication No. 2020-111282 A
[Patent Literature 3] WO 2020/036067 A1
[Patent Literature 4] German Patent Application Publication No. 102006026359 A

### SUMMARY OF THE INVENTION

As a result of intensive studies for vehicle air conditioning systems using heat pump cycles, the present inventor has found that the above problems can be solved by disposing a predetermined air conditioning device including a cooling member for allowing a refrigerant to flow in an air conditioning duct, instead of an evaporator, and he has completed the present invention. That is, the present invention is illustrated as follows:

[1]

A vehicle air conditioning system, comprising:
an air conditioning duct for allowing air from a vehicle interior to flow therethrough; and
an air conditioning device disposed within the air conditioning duct,
wherein the air conditioning device comprises: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; and a cooling member disposed over the outer peripheral wall of the honeycomb structure, the cooling member forming a flow path between the honeycomb structure and the cooling member, the flow path allowing a refrigerant to flow therethrough.
   [2]

The vehicle air conditioning system according to [1], wherein the air conditioning device further comprises a dehumidifying layer formed on each surface of the partition walls.

[3]

The vehicle air conditioning system according to [1] or [2], wherein the flow path for allowing the refrigerant to flow is connected to a heat pump cycle. The vehicle air conditioning system according to [3], further comprising a control unit for controlling the air conditioning device and the heat pump cycle depending on an operation mode.

[5] [4]

The vehicle air conditioning system according to claim [3] or [4],
wherein the air conditioning duct has two or more branched paths,
wherein the air conditioning device is disposed in each of the two or more branched paths,
wherein each of the two or more branched paths comprises: an inflow path for allowing the air to flow into the vehicle interior on a downstream side of the air conditioning device; and an outflow path for allowing the air to flow out to a vehicle exterior, and each of the two or more branched paths comprises a switching valve capable of switching the flow of the air between the inflow path and the outflow path, and
wherein the heat pump cycle comprises a condenser for performing heat exchange between heat of the refrigerant and the air in the air conditioning duct connected to the vehicle interior on the downstream side of the air conditioning device.
   [6]

The vehicle air conditioning system according to [5], wherein the operation mode of the air conditioning device comprises:
a dehumidification mode wherein the air is dehumidified by controlling the switching valves to allow the air to flow into the inflow path in all of the branched paths to circulate the air through the air conditioning device; and
a dehumidification and regeneration mode wherein the air is dehumidified by controlling the switching valve to allow the air to flow into the inflow path in a part of the branched paths to circulate the air through the air conditioning device, and the humidified layer is regenerated by controlling the switching valve to allow the air to flow out to the outflow path in the remaining branched paths to circulate the air through the air conditioning device while heating the air conditioning device.
   [7]

The vehicle air conditioning system according to [5] or [6], wherein the heat pump cycle further comprises:
a compressor for compressing and discharging the refrigerant;
an outdoor heat exchanger for exchanging heat between the refrigerant and outside air;
at least one expansion valve for expanding the refrigerant;
an outflow path internal heat exchanger for exchanging heat between the refrigerant and the heated air flowing through the outflow path;
wherein the operation mode of the heat pump cycle comprises:
a cooling operation mode wherein the air conditioning device is cooled to cool the air by allowing the refrigerant expanded by the expansion valve to flow through the air conditioning device; and
a heating operation mode wherein the refrigerant that has undergone heat exchange in the outdoor heat exchanger and the outflow path internal heat exchanger is compressed by the compressor, and the refrigerant discharged from the compressor is introduced into the condenser to heat the air.
   [8]

The vehicle air conditioning system according to any one of [1] to [7], wherein the material having the PTC property comprises barium titanate as a main component.

[9]

The vehicle air conditioning system according to any one of [1] to [8], wherein the dehumidifying layer further comprises an adsorbent having a function of adsorbing at least one selected from carbon dioxide and volatile components, and/or a catalyst.

[10]

The vehicle air conditioning system according to any one of [6] to [9], further comprising a detection portion capable of detecting fogging of glass in the vehicle interior, wherein the control unit executes the regeneration and regeneration mode when the fogging of the glass is detected, and the control unit executes the dehumidification mode when the fogging of the glass is not detected.

[11]

The vehicle air conditioning system according to [10], wherein the detection portion detects the fogging of the glass based on a temperature and a humidity in the vehicle interior.

### BRIEF DESCRIPTION OF THE DRAWINGS

FIG. 1 is a schematic configuration view of a vehicle air conditioning system according to an embodiment of the present invention;

FIG. 2A is a schematic view of a cross section of an air conditioning device used in a vehicle air conditioning system according to an embodiment of the present invention, which is parallel to a flow path direction;

FIG. 2B is a schematic cross-sectional view of the air conditioning device taken along the line a-a′ in FIG. 2A;

FIG. 3A is a schematic view of a cross section of another air conditioning device used in a vehicle air conditioning system according to an embodiment of the present invention, which is parallel to a flow path direction;

FIG. 3B is a schematic cross-sectional view of the air conditioning device taken along the line b-b′ in FIG. 3A;

FIG. 4A is a schematic configuration view of a vehicle air conditioning system according to an embodiment of the present invention, which shows an operating state during a dehumidification/cooling operation mode;

FIG. 4B is a schematic configuration view of a vehicle air conditioning system according to an embodiment of the present invention, which shows an operating state during a dehumidification and regeneration/cooling operation mode;

FIG. 4C is a schematic configuration view of a vehicle air conditioning system according to an embodiment of the present invention, which shows an operating state during a dehumidification and regeneration/cooling operation mode;

FIG. 4D is a schematic configuration view of a vehicle air conditioning system according to an embodiment of the present invention, which shows an operating state during a dehumidification and regeneration/heating operation mode;

FIG. 4E is a schematic configuration view of a vehicle air conditioning system according to an embodiment of the present invention, which shows an operating state during a dehumidification and regeneration/heating operation mode; and

FIG. 4F is a schematic configuration view of a vehicle air conditioning system according to an embodiment of the present invention, which shows an operating state during a regeneration/uncooling-heating operation mode.

### DETAILED DESCRIPTION OF THE INVENTION

The vehicle air conditioning system according to the present invention includes: an air conditioning duct for allowing air from a vehicle interior to flow therethrough; and an air conditioning device disposed within the air conditioning duct, wherein the air conditioning device includes: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; and a cooling member disposed over the outer peripheral wall of the honeycomb structure, the cooling member forming a flow path between the honeycomb structure and the cooling member, the flow path allowing a refrigerant to flow therethrough. By this configuration, the vehicle air conditioning system according to the present invention can perform dehumidification and cooling operations without using an evaporator. Therefore, various problems caused by the evaporator (e.g., dust and the like adhering to the evaporator due to condensation, causing mold, damaging the vehicle interior environment, and causing allergic symptoms in the driver, and increasing ventilation resistance, etc.) can be eliminated.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

The vehicle air conditioning system according to an embodiment of the present invention can be suitably utilized for various vehicles such as automobiles. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to the embodiment of the present invention can be particularly suitably used for a vehicle having no internal combustion engine such as electric vehicles and electric railcars.

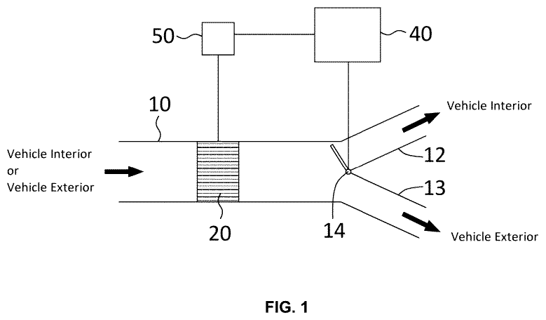

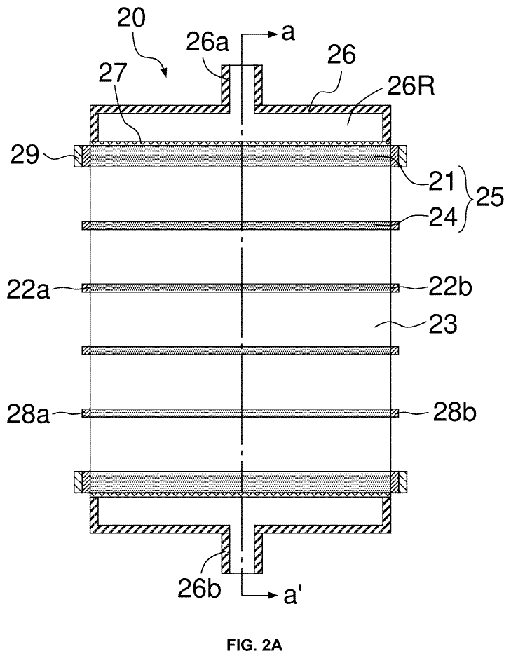

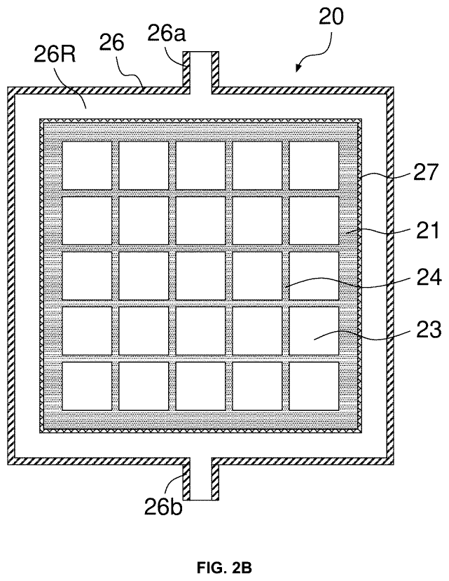

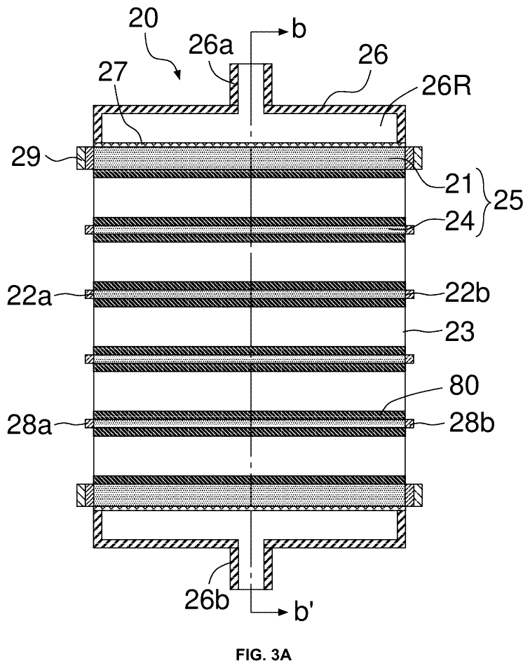

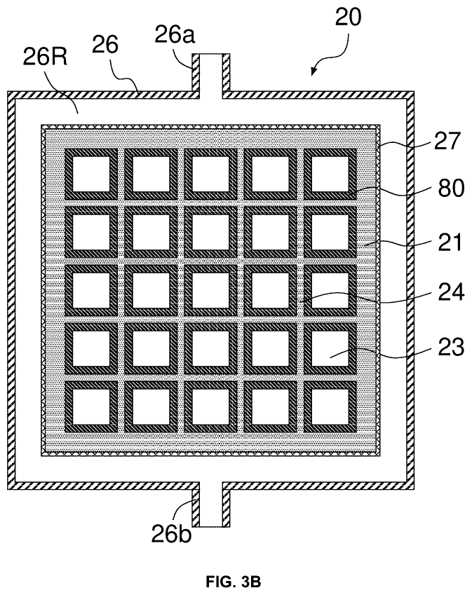

FIG. 1 is a schematic configuration view of a vehicle air conditioning system according to an embodiment of the present invention. FIG. 2A is a schematic view of a cross section of an air conditioning device used in a vehicle air conditioning system according to an embodiment of the present invention, which is parallel to a flow path direction. FIG. 2B is a schematic cross-sectional view of the air conditioning device taken along the line a-a′ in FIG. 2A. FIG. 3A is a schematic view of a cross section of another air conditioning device used in a vehicle air conditioning system according to an embodiment of the present invention, which is parallel to a flow path direction, and FIG. 3B is a schematic cross-sectional view of the air conditioning device taken along the line b-b′ in FIG. 3A.

As shown in FIG. 1, the vehicle air conditioning system according to the present invention includes: an air conditioning duct 10 for allowing air from a vehicle interior to flow therethrough; and an air conditioning device 20 disposed within the air conditioning duct 10. The vehicle air conditioning system can further include a power source 50 for applying a voltage to the air conditioning device 20 and a control unit 40 for controlling the power source 50.

As shown in FIGS. 2A and 2B, the air conditioning device 20 includes: a honeycomb structure 25 having an outer peripheral wall 21 and partition walls 24 disposed on an inner side of the outer peripheral wall 21, the partition walls 24 defining a plurality of cells 23, each of the cells 23 extending from a first end face 22a to a second end face 22b to form a flow path, at least the partition walls 24 being made of a material having a PTC property; and a cooling member 26 disposed over the outer peripheral wall 21 of the honeycomb structure 25, the cooling member 26 forming a flow path 26R between the honeycomb structure 25 and the cooling member 26, the flow path 26R allowing a refrigerant to flow therethrough. The air conditioning device 20 can further include an insulation layer 27 formed on the outer surface of the outer peripheral wall 21 parallel to the extending direction of the cells 23, a pair of electrodes 28a, 28b for applying a voltage to the honeycomb structure 25, and terminals 29 connected to the pair of electrodes 28a, 28b.

In the vehicle air conditioning system having the above configuration, the air from the vehicle interior or the vehicle exterior flows into the air conditioning device 20 through the air conditioning duct 10. The air conditioning device 20 is cooled by the cooling member 26 through which the refrigerant flows, and similarly to an evaporator used in the conventional vehicle air conditioning system, the air conditioning device 20 can cool the air, and condenses and removes moisture in the air. The cooled and dehumidified air then returns to the vehicle interior through the air conditioning duct 10.

Although the method for discharging the moisture in the air condensed in the air conditioning device 20 is not particularly limited, it is preferable that the air conditioning duct 10 is provided with an outflow path 13 for discharging the moisture. That is, the air conditioning duct 10 preferably has an inflow path 12 for allowing the air to flow into the vehicle interior on a downstream side of the air conditioning device 20, and an outflow path 13 for allowing the air to flow out to the vehicle exterior. Further, it is preferable that a switching valve 14 capable of switching the flow of the air is provided between the inflow path 12 and the outflow path 13. In the vehicle air conditioning system having such a structure, a voltage can be applied to the pair of electrodes 28a, 28b to heat the honeycomb structure 25, thereby evaporating condensed water and discharging it to the vehicle exterior through the outflow path 13.

The air conditioning device 20 may further include a dehumidifying layer 80 formed on each surface of the partition walls 24, as shown in FIGS. 3A and 3B. By using such an air conditioning device 20, the moisture in the air can be trapped (removed) by the dehumidifying layer 80 while the air from the vehicle interior or the vehicle exterior passes through the air conditioning device 20, thereby improving dehumidification performance. Furthermore, the dehumidifying layer 80 is directly heated by the heating of the honeycomb structure 25, so that the moisture trapped in the dehumidifying layer 80 is efficiently desorbed or reacted and released from the dehumidifying layer 80, so that the moisture can be discharged from the outflow path 13 to the vehicle exterior.

It is preferable that the flow path 26R for allowing the refrigerant to flow, which is formed between the honeycomb structure 25 and the cooling member 26, is connected to a heat pump cycle 30. By connecting the flow path 26R to the heat pump cycle 30, an air conditioning operation similar to that of a vehicle air conditioning system using the conventional heat pump cycle can be performed.

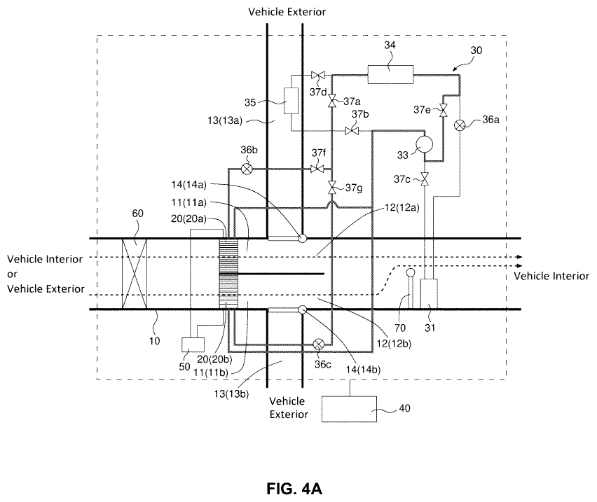

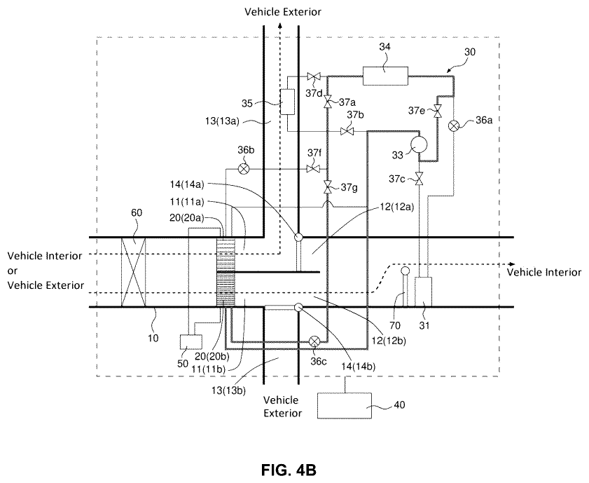

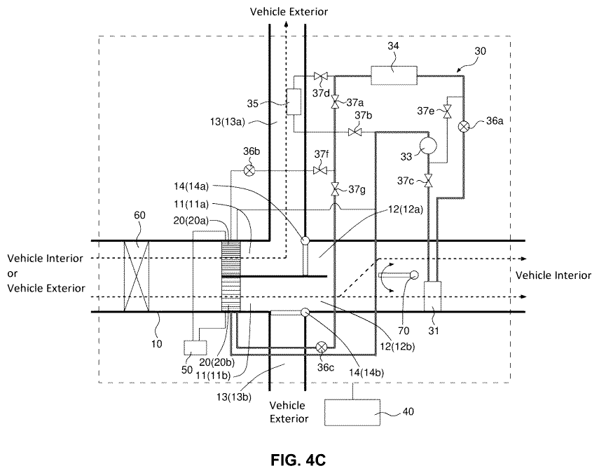

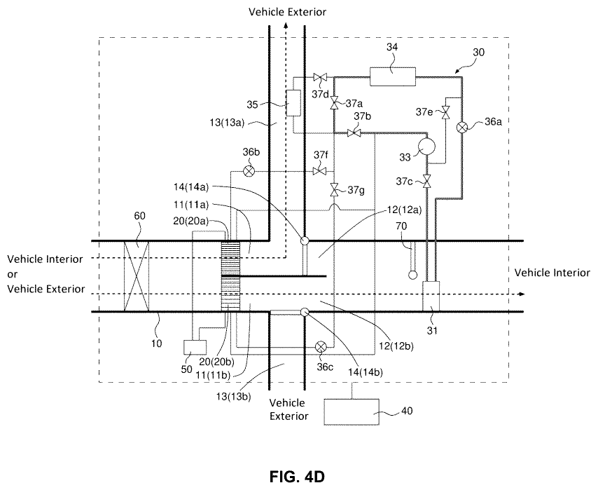

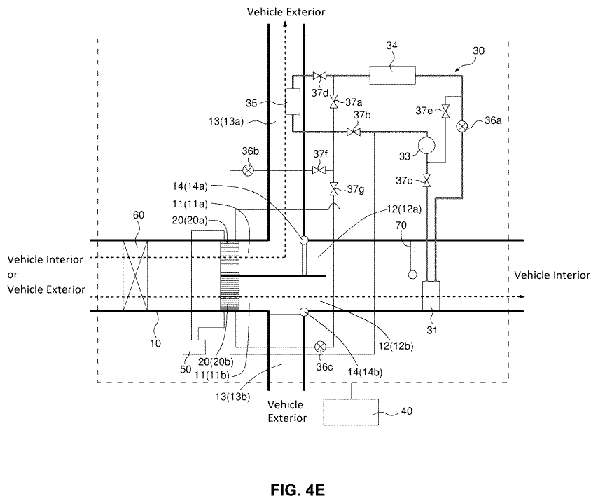

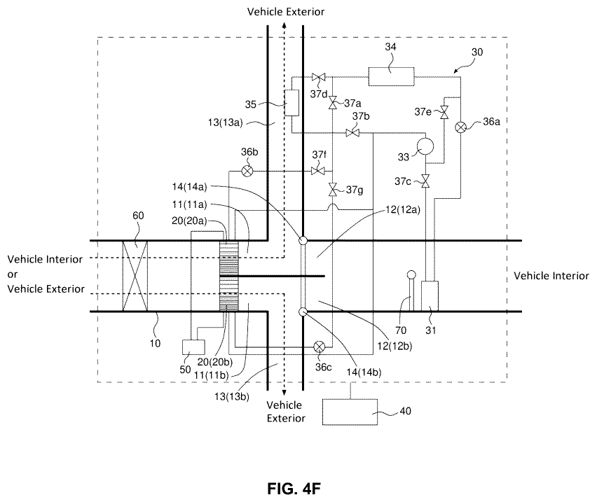

Each of FIGS. 4A to 4F is a schematic configuration view of a vehicle air conditioning system according to another embodiment of the present invention, which shows an operating state during each operation mode. In particular, FIG. 4A is the dehumidification/cooling operation mode, FIGS. 4B and 4C are the dehumidification and regeneration/cooling operation mode, FIGS. 4D and 4E are the dehumidification and regeneration/heating operation mode, and FIG. 4F is the regeneration/un-cooling-heating operation mode.

The vehicle air conditioning system according to another embodiment of the present invention includes: an air conditioning duct 10; an air conditioning device 20; a heat pump cycle 30; and a control unit 40. Further, the vehicle air conditioning system can further include: a power source 50; a ventilation fan 60; and an air mix door 70.

Hereinafter, each of these components will be described in detail.

### (1. Air Conditioning Duct 10)

The air conditioning duct 10 has two or more branched paths 11 (11a, 11b). The two or more branched paths 11 (11a, 11b) include inflow paths 12 (12a, 12b) for allowing the air to flow into the vehicle interior on the downstream side of the air conditioning devices 20, and outflow paths 13 (13a, 13b) for allowing the air to flow out to the vehicle exterior, and are provide with switching valves 14 (14a, 14b) capable of switching the flow of the air between the inflow paths 12 (12a, 12b) and the outflow paths 13 (13a, 13b). It is preferable that the inflow paths 12 (12a, 12b) merge on the downstream side to form one flow path.

The number of branched paths 11 of the air conditioning duct 10 is not particularly limited as long as the number is two or more, but it may preferably be 2 to 5, more preferably 2 to 4, and even more preferably 2 to 3.

The shape and size of the air conditioning duct 10 may be adjusted as needed depending on the type of the vehicle and the like, and are not particularly limited.

The switching valves 14 (14a, 14b) can be provided at branched portions between the inflow paths 12 (12a, 12b) and the outflow paths 13 (13a, 13b).

The switching of the switching valves 14 (14a, 14b) can be performed, for example, by electrically connecting the control unit 40 to the switching valves 14 (14a, 14b) by wire or wirelessly, and operating the switches of the switching valves 14 (14a, 14b) by the control unit 40.

The switching valves 14 (14a, 14b) are not particularly limited as long as they are electrically driven and have the function of switching the flow paths, and include electromagnetic valves and electric valves. For example, each of the switching valves 14 (14a, 14b) can include an opening/closing door supported by a rotating shaft and an actuator such as a motor for rotating the rotating shaft. The actuator is configured to be controllable by the control unit 40.

### (2. Air Conditioning Device 20)

The air conditioning devices 20 (20a, 20b) are disposed in the two or more branched paths 11 (11a, 11b), respectively.

Each of the air conditioning devices 20 (20a, 20b) includes: a honeycomb structure including: an outer peripheral wall 21 and partition walls 24 that are disposed on an inner side of the outer peripheral wall 21 and define a plurality of cells 23 each extending from a first end face 22a to a second end face 22b to form a flow path, wherein at least the partition walls 24 are made of a material having a PTC property; and a cooling member 26 disposed over the outer peripheral wall 21 of the honeycomb structure 25, the cooling member 26 allowing a refrigerant to flow therethrough. Also, each air conditioning device 20 further includes: an insulating layer 27 formed on the outer peripheral surface of the outer peripheral wall 21 parallel to the extending direction of the cells 23; a pair of electrodes 28a, 28b for applying a voltage to the honeycomb structure 25; and terminals 29 connected to the pair of electrodes 28a, 28b. Furthermore, the air conditioning device 20 may further include a dehumidifying layer 80 formed on each surface of the partition walls 24.

### (2-1. Honeycomb Structure 25)

The shape of the honeycomb structure 25 is not particularly limited. For example, an outer shape of a cross section of the honeycomb structure 25 orthogonal to the flow path direction of the honeycomb structure 25 (the extending direction of the cells 23) can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 22a and second end face 22b) have the same shape as the cross section. Also, when the cross section and the end faces are polygonal, the corners may be chamfered.

The shape of each cell 23 is not particularly limited, but it may be polygonal such as quadrangular, pentagonal, hexagonal, heptagonal, and octagonal, circular, or oval in the cross section of the honeycomb structure 25 orthogonal to the flow path direction. These shapes may be alone or in combination of two or more. Moreover, among these shapes, the quadrangle or the hexagon is preferable. By providing the cells 23 having such a shape, it is possible to reduce the pressure loss when the air flows.

The honeycomb structure 25 may be a honeycomb joined body having a plurality of honeycomb segments and joining layers that join outer peripheral side surfaces of the plurality of honeycomb segments together. The use of the honeycomb joined body can increase the total cross-sectional area of the cells 23, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain a material having the PTC property, or may contain the same material as the outer peripheral wall 21 and the partition walls 24. In addition to the role of joining the honeycomb segments to each other, the joining material can also be used as an outer peripheral coating material after joining the honeycomb segments.

From the viewpoints of ensuring the strength of the honeycomb structure 25, reducing pressure loss when air passes through the cells 23, ensuring the amount of functional material supported, and ensuring the contact area with the air flowing inside the cells 23, it is desirable to suitably combine a thickness of the partition wall 24, a cell density, and a cell pitch (or an opening ratio of the cells 23).

As used herein, the cell density refers a value obtained by dividing a number of cells by an area of one end face (first end face 22a or second end face 22b) of the honeycomb structure 25 (the total area of the partition walls 24 and the cells 23 excluding the outer peripheral wall 21).

As used herein, the cell pitch refers to a value obtained by the following calculation. First, the area of one end face (first end face 22a or second end face 22b) of the honeycomb structure 25 (the total area of the partition walls 24 and the cells 23 excluding the outer peripheral wall 21) is divided by the number of the cells to calculate an area per a cell. A square root of the area per a cell is then calculated, and this is determined to be the cell pitch.

As used herein, the opening ratio of the cells 23 refers a value obtained by dividing the total area of the cells 23 defined by the partition walls 24 by the area of one end face 12b (first end face 22a or second end face 22b) (the total area of the partition walls 24 and the cells 23 excluding the outer peripheral wall 21) in the cross section orthogonal to the flow path direction of the honeycomb structure 25. It should be noted that when calculating the opening ratio of the cells 23, the pair of electrodes 28a, 28b, and the dehumidifying layer 80 are not taken into account.

In an embodiment that is advantageous from the viewpoint of supporting a sufficient amount of functional material, the thickness of the partition wall 24 is 0.300 mm or less, the cell density is 100 cells/cm² or less, and the cell pitch is 1.0 mm or more. In a preferred embodiment, the thickness of the partition wall 24 is 0.200 mm or less, the cell density is 70 cells/cm² or less, and the cell pitch is 1.2 mm or more. In a more preferred embodiment, the thickness of the partition wall 24 is 0.130 mm or less, the cell density is 65 cells/cm² or less, and the cell pitch is 1.3 mm or more.

From the viewpoints of ensuring the strength of the honeycomb structure 25 and maintaining lower electrical resistance, the lower limit of the thickness of the partition wall 24 is preferably 0.010 mm or more, and more preferably 0.020 mm or more, and even more preferably 0.030 mm or more.

From the viewpoints of ensuring the strength of the honeycomb structure 25, maintaining lower electrical resistance, and increasing a surface area to facilitate reaction, adsorption, and release, the lower limit of the cell density is 30 cells/cm² or more, and preferably 35 cells/cm² or more, and even more preferably 40 cells/cm² or more.

From the viewpoints of ensuring the strength of the honeycomb structure 25, maintaining lower electrical resistance and increasing a surface area to facilitate reaction, adsorption and release, the upper limit of the cell pitch is 2.0 mm or less, and more preferably 1.8 mm or less, and even more preferably 1.6 mm or less.

In an embodiment that is advantageous in terms of both reducing pressure loss and maintaining strength, the thickness of the partition wall 24 is 0.08 to 0.36 mm, the cell density is 2.54 to 140 cells/cm², and the opening ratio of the cells 23 is 0.70 or more. In a preferred embodiment, the thickness of the partition wall 24 is 0.09 to 0.35 mm, the cell density is 15 to 100 cells/cm², and the opening ratio of the cells 23 is 0.80 or more. In a more preferred embodiment, the thickness of the partition wall 24 is 0.14 to 0.30 mm, the cell density is 20 to 90 cells/cm², and the opening ratio of the cells 23 is 0.85 or more.

From the viewpoint of ensuring the strength of the honeycomb structure 25, the upper limit of the opening ratio of the cells 23 is preferably 0.94 or less, and more preferably 0.92 or less, and even more preferably 0.90 or less.

Although the thickness of the outer peripheral wall 21 is not particularly limited, it is preferably determined based on the following viewpoints. First, from the viewpoint of reinforcing the honeycomb structure 25, the thickness of the outer peripheral wall 21 is preferably 0.05 mm or more, and more preferably 0.06 mm or more, and even more preferably 0.08 mm or more. On the other hand, the thickness of the outer peripheral wall 21 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

As used herein, the thickness of the outer peripheral wall 21 refers to a length from a boundary between the outer peripheral wall 21 and the outermost cell 23 or the partition wall 24 to a side surface of the honeycomb structure 25 in a normal line direction of the side surface in the cross section orthogonal to the flow path direction of the honeycomb structure 25.

The length in the flow path direction and the cross-sectional area orthogonal to the flow path direction of the honeycomb structure 25 may be adjusted according to the required size of the air conditioning device 20, and are not particularly limited. For example, when used in a compact air conditioning device 20 while ensuring a predetermined function, the honeycomb structure 25 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 24 forming the honeycomb structure 25 are made of a material that can be heated by electric conduction, specifically made of a material having the PTC property (Positive Temperature Coefficient). Further, the outer peripheral wall 21 may also be made of the material having the PTC property, as with the partition walls 24, as needed. By such a configuration, the dehumidifying layer 80 can be directly heated by heat transfer from the heat-generating partition walls 24 (and optionally the outer peripheral wall 21). Further, the material having the PTC property has characteristics such that when the temperature increases to exceed the Curie point, the resistance value is sharply increased, resulting in a difficulty for electricity to flow. Therefore, when the temperature of the partition walls 24 (and the outer peripheral wall 21 if necessary) becomes high, the current flowing through them is limited, thereby suppressing excessive heat generation of the honeycomb structure 25. Therefore, it is possible to suppress thermal deterioration of the dehumidifying layer 80 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 30 Ω·cm or less, and more preferably 18 Ω·cm or less, and even more preferably 16 Ω·cm or less, from the viewpoint of generating heat with a low driving voltage. As used herein, the volume resistivity at 25° C. of the material having the PTC property is measured according to JIS K 6271:2008.

From the viewpoints that can be heated by electric conduction and has the PTC property, the outer peripheral wall 21 and the partition walls 24 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer peripheral wall 21 and the partition walls 24 are substantially free of lead (Pb). More particularly, the outer peripheral wall 21 and the partition walls 24 preferably have a Pb content of 0.01% by mass or less, and more preferably 0.001% by mass or less, and still more preferably 0% by mass. The lower Pb content can allow the air heated by contact with the heat-generating partition walls 24 to be safely applied to organisms such as humans, for example. In the outer peripheral wall 21 and the partition walls 24, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 21 and the partition walls 24 preferably has a Curie point in a temperature range where the resistance value becomes twice or more the resistance at room temperature (25° C.). If the Curie point is in such a temperature range, the current flowing through the air conditioning device 20 is limited when the air conditioning device 20 reaches a high temperature, so that excessive heat generation of the air conditioning device 20 is efficiently suppressed. Therefore, thermal deterioration of the dehumidifying layer 80 caused by excessive heat generation can be suppressed.

The material making up the outer peripheral wall 21 and the partition walls 24 preferably have a lower limit of a Curie point of 80° C. or more, and more preferably 100° C. or more, and even more preferably 110° C. or more, and still more preferably 125° C. or more, in terms of efficiently heating the dehumidifying layer 80. Further, the upper limit of the Curie point is preferably 200° C. or more, and preferably 190° C. or more, and even more preferably 180° C. or more, and particularly preferably 150° C. or more, in terms of safety as a component placed in the vehicle interior or near the vehicle interior.

The Curie point of the material making up the outer peripheral wall 21 and the partition walls 24 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. Cooling Member 26)

The cooling member 26 is disposed so as to be covered with the outer peripheral wall 21 of the honeycomb structure 25, and forms a flow path 26R between the honeycomb structure 25 and the cooling member 26, the flow path 26 allowing the refrigerant to flow therethrough. That is, the cooling member 26 is spaced outwardly in the radial direction of the honeycomb structure 25 so as to form the flow path 26R for allowing the refrigerant to flow between the honeycomb structure 25 and the cooling member 26.

The cooling member 26 has a feed port 26a that can feed the refrigerant and a discharge port 26b that can discharge the refrigerant. The feed port 26a and the discharge port 26b for the refrigerant can be connected to the heat pump cycle 30.

It is preferable that the axial direction of the cooling member 26 coincides with the axial direction of the honeycomb structure 25, and the central axis of the cooling member 26 coincides with the central axis of the honeycomb structure 25.

The shape of the cooling member 26 is not particularly limited, and it can be various cylindrical shapes such as a cylindrical shape and a rectangular cylindrical shape.

The diameter (outer diameter and inner diameter) of the cooling member 26 may be uniform in the axial direction, but the diameter of at least a portion (for example, the axial central portion, both axial end portions, etc.) may be decreased or increased.

It should be noted that when the cooling member 26 is not cylindrical, the outer diameter and inner diameter of the cooling member 26 mean the diameters of the largest circle that circumscribes and inscribes the cross-sectional shape perpendicular to the axial direction of the cooling member 26.

The material of the cooling member 26 is not particularly limited, but a metal is preferable from the viewpoint of manufacturability. Examples of the material of the cooling member 26 that can be used herein include stainless steel, titanium alloys, copper alloys, aluminum, aluminum alloys, brass, and the like, and aluminum is preferable.

### (2-3. Insulating Layer 27)

The insulating layer 27 is formed on the outer peripheral surface of the outer peripheral wall 21 parallel to the extending direction of the cells 23 of the honeycomb structure 25. The insulating layer 27 suppresses the electrical conduction of the cooling member 26 when applying a voltage to the honeycomb structure 25.

The material making up the insulating layer 27 is not particularly limited, and known materials can be used.

The insulating layer 27 preferably has excellent thermal conductivity from the viewpoint of efficiently cooling the honeycomb structure 25 by the refrigerant flowing through the flow path 26R. For example, a Si layer can be used as the insulating layer 27 having excellent thermal conductivity.

The thickness of the insulating layer 27 is not particularly limited as long as insulation performance is ensured, but it is typically about 1 mm.

The method for forming the insulating layer 27 is not particularly limited, and it can be formed by a known method such as a coating method or a vapor deposition method.

### (2-4. Pair of Electrodes 28a, 28b)

Although the positions of the pair of electrodes 28a, 28b are not particularly limited, but they can be provided on the first end face 22a and the second end face 22b.

Applying of a voltage between the pair of electrodes 28a, 28b allows the honeycomb structure 25 to generate heat by Joule heat.

The pair of electrodes 28a, 28b may employ, for example, a metal or alloy containing at least one selected from Cu, Ag, Al, Ni and Si, although not particularly limited thereto. It is also possible to use an ohmic electrode capable of ohmic contact with the outer peripheral wall 21 and/or the partition walls 24 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 28a, 28b may have a single-layer structure, or may have a laminated structure of two or more layers. When the pair of electrodes 28a, 28b have the laminated structure of two or more layers, the materials of the respective layers may be of the same type or of different types.

The thickness of the pair of electrodes 28a, 28b may be appropriately set according to the method for forming the pair of electrodes 28a, 28b. The method for forming the pair of electrodes 28a, 28b includes metal deposition methods such as sputtering, vapor deposition, electrolytic deposition, and chemical deposition. Alternatively, the pair of electrodes 28a, 28b can be formed by applying an electrode paste and then baking it, or by thermal spraying. Furthermore, the pair of electrodes 28a, 28b may be formed by joining metal sheets or alloy sheets.

Each of the thicknesses of the pair of electrodes 28a, 28b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### (2-5. Terminal 29)

The terminals 29 are connected to the pair of electrodes 28a, 28b and provided on at least a part of the pair of electrodes 28a, 28b. The provision of the terminals 29 facilitates connection to an external power source. The terminals 29 are connected to conducing wires connected to the power source 50.

The terminals 29 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 29 are not particularly limited. For example, as shown in FIGS. 2A and 3A, the terminals 29 can be provided on the whole of the pair of electrodes 28a, 28b on the outer peripheral wall 21. Further, the terminals 29 may be provided on a part of the pair of electrodes 28a, 28b on the outer peripheral wall 21, or may be provided so as to extend toward an outer side than the outer edge of each of the pair of electrodes 28a, 28b on the outer peripheral wall 21. Further, the terminals 29 may be provided on a part of the pair of electrodes 28a, 28b on the partition walls 24, or may be provided so as to block a part of the cells 23.

Furthermore, the thickness of the terminal 29 is not particularly limited, but it is, for example, 0.01 to 10 mm, typically 0.05 to 5 mm.

The method of connecting the terminals 29 to the pair of electrodes 28a, 28b is not particularly limited as long as they are electrically connected. For example, they can be connected by diffusion bonding, a mechanical pressing mechanism, welding, or the like.

### (2-6. Dehumidifying Layer 80)

The dehumidifying layer 80 can be provided on the surfaces of the partition walls 24 (in the case of the outermost cells 23, the partition walls 24 that define the outermost cells 23 and the outer peripheral wall 21). By thus providing the dehumidifying layer 80, the dehumidifying layer 80 can be easily heated during the regeneration process, so that the moisture adsorbing function by the dehumidifying layer 80 can be regenerated.

The dehumidifying layer 80 contains a dehumidifying material. The dehumidifying material is not particularly limited, but a moisture absorbent can be used.

The moisture adsorbent preferably has a function that can adsorb the moisture (water vapor) at −20 to 40° C. and release them at an elevated temperature of 60° C. or more. Examples of the moisture absorbent having such a function include aluminosilicate, silica gel, silica, graphene oxide, polymer moisture absorbents, polystyrene sulfonic acid, and metal organic frameworks (MOFs: Metal Organic Frameworks). These may be used alone or in combination of two or more.

Examples of the aluminosilicate that can be preferably used herein include AFI type-, CHA type-, or BEA type-zeolite; and porous clay minerals such as allophane and imogolite. Also, it is more preferable that the aluminosilicate is amorphous.

Examples of the silica gel that can be preferably used herein include type A silica gel.

Examples of the polymer moisture adsorbents that can be preferably used herein include those having a polyacrylic acid polymer chain. For example, sodium polyacrylate or the like can be used as the polymer moisture adsorbent.

The metal organic framework is a crystalline hybrid material containing metal ions and organic molecules (organic ligands). The metal ions are preferably hydrophilic metal ions (for example, aluminum ions).

The dehumidifying layer 80 can contain a functional material other than the dehumidifying material, and/or a catalyst. The functional material other than the dehumidifying material is not particularly limited as long as it can exhibit the desired function, but an adsorbent and the like can be used. The adsorbent preferably has a function of adsorbing at least one selected from carbon dioxide and volatile components. Also, the use of the catalyst allows the components to be removed to be purified. Furthermore, the adsorbent and the catalyst may be used together for the purpose of enhancing the function of the absorbent to capture the components to be removed.

Examples of the adsorbent include zeolite, silica gel, activated carbon, alumina, silica, low-crystalline clay, amorphous aluminum silicate complexes, and the like. Some of these components also function as the dehumidifying material. The adsorbent may be used alone, or in combination with two or more types.

The catalyst preferably has a function capable of promoting the oxidation-reduction reaction. The catalysts having such functions include metal catalysts such as Pt, Pd and Ag, and oxide catalysts such as CeO₂ and ZrO₂. The catalyst may be used alone, or in combination with two or more types.

The volatile components contained in the air in the vehicle interior include, for example, volatile organic compounds (VOCs), and odor components other than the VOCs Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the dehumidifying layer 80 may be determined according to the size of the cells 23, and is not particularly limited. For example, the thickness of the dehumidifying layer 80 is preferably 20 μm or more, and more preferably 25 μm or more, and even more preferably 30 μm or more, from the viewpoint of ensuring sufficient contact with air. On the other hand, the thickness of the dehumidifying layer 80 is preferably 400 μm or less, and more preferably 380 μm or less, and even more preferably 350 μm or less, from the viewpoint of suppressing separation of the dehumidifying layer 80 from the partition walls 24 and the outer peripheral wall 21.

The thickness of the dehumidifying layer 80 is measured using the following procedure. Any cross section parallel to the flow path direction of the honeycomb structure 25 is cut out, and a cross-sectional image at magnifications of about 50 is acquired using a scanning electron microscope or the like. Also, this cross section is made to pass through the center of gravity position in the cross section orthogonal to the flow path of the honeycomb structure 25. The thickness of each dehumidifying layer 80 visually recognized from the cross-sectional image is calculated by dividing the cross-sectional area by the length of the cells 23 in the flow path direction. This calculation is performed for all the dehumidifying layers 80 visually recognized from the cross-sectional image, and an average value thereof is determined to be the thickness of the dehumidifying layer 80.

From the viewpoint that the functional material and the like exhibit the desired function in the air conditioning device 20, an amount of the dehumidifying layer 80 is preferably 50 to 500 g/L, and more preferably 100 to 400 g/L, and even more preferably 150 to 350 g/L, based on the volume of the honeycomb structure 25. It should be noted that the volume of the honeycomb structure 25 is a value determined by the external dimensions of the honeycomb structure 25.

### (2-7. Method for Producing Air Conditioning Device 20)

The method for producing the air conditioning device 20 is not particularly limited, and it can be performed according to a known method. Hereinafter, the method for producing the air conditioning device 20 will be illustratively described.

A method for producing the honeycomb structure 25 forming the air conditioning device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 65% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 25 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 25 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 25.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the honeycomb structure 25 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

On the honeycomb structure 25 thus obtained, the pair of electrodes 28a, 28b are formed. The pair of electrodes 28a, 28b can be formed by metal deposition methods such as sputtering, vapor deposition, electrolytic deposition, and chemical deposition. Further, the pair of electrodes 28a, 28b can also be formed by applying an electrode paste and then baking it. Furthermore, the pair of electrodes 28a, 28b can also be formed by thermal spraying. The pair of electrodes 28a, 28b may be composed of a single layer, but may also be composed of a plurality of electrode layers having different compositions. A typical method for forming the pair of electrodes 28a, 28b will be described below.

First, an electrode slurry containing an electrode material, an organic binder, and a dispersion medium is prepared, and the first end face 22a or the second end face 22b of the honeycomb structure 25 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 25 is removed by blowing and wiping. The slurry can be then dried to form the pair of electrodes 28a, 28b on the first end face 22a or the second end face 22b of the honeycomb structure 25. The drying can be performed while heating the vehicle air conditioning system to a temperature of about 120 to 600° C., for example. Although a series of steps of coating, slurry removal, and drying may be performed only once, the steps can be repeated multiple times to provide the pair of electrodes 28a, 28b having desired thicknesses.

When the terminals 29 are provided, they are then disposed at predetermined positions of the pair of electrodes 28a, 28b, and the pair of electrodes 28a, 28b and the terminals 29 are connected to each other. As a method of connecting the pair of electrodes 28a, 28b to the terminals 29, the method described above can be used.

It should be noted that the terminals 29 may be disposed after forming a dehumidifying layer 80 described below.

The dehumidifying layer 80 is then formed on the surfaces of the partition walls 24 and the like of the honeycomb structure 25.

Although the method for forming the dehumidifying layer 80 is not particularly limited, it can be formed, for example, by the following steps. The honeycomb structure 25 is immersed in a slurry containing a dehumidifying material, an organic binder, and a dispersion medium for a predetermined period of time, and an excess slurry on the end faces and the outer periphery of the honeycomb structure 25 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the dehumidifying layer 80 on the surfaces of the partition walls 24. The drying can be performed while heating the honeycomb structure 25 to a temperature of about 120 to 600° C., for example. Although a series of steps of immersion, slurry removal, and drying may be performed only once, the steps can be repeated multiple times to provide the dehumidifying layer 80 having the desired thickness on the surfaces of the partition walls 24 and the like.

### (3. Heat Pump Cycle 30)

The heat pump cycle 30 includes a condenser 31 disposed within the air conditioning duct 10 connected to the vehicle interior on the downstream side of the air conditioning device 20.

The condenser 31 can exchange heat between the refrigerant and the air. Specifically, the condenser 31 is capable of dissipating the heat by the refrigerant at elevated temperature and high pressure flowing therethrough, and heats the air passing around the condenser 31.

In addition to the condenser 31, the heat pump cycle 30 can further include: a compressor 33; an outdoor heat exchanger 34; an outflow path internal heat exchanger 35; expansion valves 36a, 36b, 36c; and shutoff valves 37a to 37g. Each of these members is connected via the refrigerant flow path.

The compressor 33 has a function of compressing and discharging the refrigerant. The compressor 33 has a suction portion connected to the heat exchangers (the outdoor heat exchanger 34, the outflow path internal heat exchanger 35), and a discharge portion connected to the condenser 31 via the refrigerant flow path. The compressor 33 is driven by the control unit 40 and discharges the high-temperature, high-pressure refrigerant to the condenser 31 by compressing the refrigerant.

It should be noted that a known device such as a gas-liquid separator may be provided between the compressor 33 and the heat exchanger.

The outdoor heat exchanger 34 has a function of performing heat exchange between the heat of the refrigerant and the outside air. The outdoor heat exchanger 34 is capable of absorbing the heat from the outside air using a low-temperature, low-pressure refrigerant flowing therethrough, mainly when executing the heating operation mode, and vaporizes the refrigerant by absorbing the heat from the outside air. Moreover, the outdoor heat exchanger 34 can release the heat to the outside air by the high-temperature, high-pressure refrigerant flowing therethrough, and cools the refrigerant by releasing the heat to the outside air, mainly when executing the cooling operation mode.

The outflow path internal heat exchanger 35 has a function of performing heat exchange between the heat of the refrigerant and the heated air flowing through the outflow paths 13 (13a, 13b). The outflow path internal heat exchanger 35 is capable of absorbing the heat from the heated air by the refrigerant flowing therethrough, mainly when executing the heating operation mode, and increases the temperature of the refrigerant by absorbing the heat from the outside air.

Although FIGS. 4A to 4F show examples in which the outflow path internal heat exchanger 35 is provided only in the outflow path 13a, it should be noted that the outflow path internal heat exchanger 35 may also be provided in the outflow path 13b.

The expansion valves 36a, 36b, 36c are throttle valves whose opening degrees can be adjusted by the control unit 40. In particular, when the heating operation mode is executed, the expansion valve 36a reduces the pressure of the refrigerant discharged from the condenser 31 to expand it, and then discharges the low-temperature, low-pressure refrigerant to the outdoor heat exchanger 34. Furthermore, when the cooling operation mode is executed, the expansion valves 36b, 36c reduce the pressure of the refrigerant from the outdoor heat exchanger 34 to expand it, and then discharge the low-temperature, low-pressure refrigerant to the flow path 26R of the air conditioning device 20.

The shutoff valves 37a to 37g are provided to control the flow path of the refrigerant. The opening and closing of the shutoff valves 37a to 37g are controlled by the control unit 40.

### (4. Control Unit 40)

The control unit 40 controls the air conditioning device 20 and the heat pump cycle 30 depending on the operation mode. Therefore, the control unit 40 is electrically connected to the air conditioning device 20 and the heat pump cycle 30. Specifically, it is connected to a power source 50 for applying a voltage to the pair of electrodes 28a, 28b of the air conditioning device 20, and the power source 50 can be controlled to adjust the heating state of the honeycomb structure 25. Further, the control unit 40 is electrically connected to the shutoff valves 37a to 37g of the heat pump cycle 30, and can control the refrigerant flow path by opening and closing the shutoff valves 37a to 37g. Further, the control unit 40 is electrically connected to the expansion valves 36a, 36b, 36c of the heat pump cycle 30, and can control the degree of pressure reduction of the refrigerant by adjusting the opening degrees of the expansion valves 36a, 36b, 36c.

The control unit 40 is electrically connected to a switching valve 14, a ventilation fan 60, an air mix door 70, and the like, in addition to the air conditioning device 20 and the heat pump cycle 30, and it can control these members.

The control unit 40 is generally an ECU (Engine (electronic) Control Unit), although not particularly limited thereto. The ECU includes a CPU for performing various calculation processes, a ROM for storing programs and data required for its control, a RAM for temporarily storing results of calculations performed by the CPU, and input/output ports for inputting and outputting signals to and from the outside.

### (5. Power Source 50)

The power source 50 is for applying a voltage to the pair of electrodes 28a, 28b. The power source 50 is electrically connected to the control unit 40, and adjusts the state of the voltage applied to the pair of electrodes 28a, 28b according to instructions from the control unit 40.

The power source 50 is not particularly limited, and a battery or the like can be used.

### (6. Ventilation Fan 60)

The ventilation fan 60 is provided to circulate the air through the air conditioning duct 10. The ventilation fan 60 is not particularly limited, and any known ventilation fan can be used.

The position of the ventilation fan 60 is not particularly limited, and it may be provided on an upstream side of the air conditioning device 20. However, the ventilation fan may be provided on a downstream side of the condenser 31.

### (7. Air Mix Door 70)

The air mix door 70 is configured to rotate in the air conditioning duct 10 between a heating position that opens a heating path toward the condenser 31 and a cooling position that opens a cooling path that bypasses the condenser 31. Furthermore, by rotating the air mix door 70 between the heating position and the cooling position, it can adjust a ratio of the air passing through the condenser 31 to the air bypassing the condenser 31, thereby adjusting the temperature of the air flowing into the vehicle interior.

In the vehicle air conditioning system according to the embodiment of the present invention, the operation modes of the air conditioning devices 20 (20a, 20b) can include a dehumidification mode, a regeneration mode, and a dehumidification and regeneration mode. The operation modes of the air conditioning devices 20 (20a, 20b) preferably include a dehumidification mode and a dehumidification and regeneration mode. The operation modes of the air conditioning devices 20 (20a, 20b) can be selected according to switch operations by the driver, changes in humidity detected by various detection units, and the like.

### (A) Dehumidification Mode

As shown in FIG. 4A, the dehumidification mode dehumidifies the air by controlling the switching valves 14 (14a, 14b) in all the branched paths 11 (11a, 11b) to allow the air to flow into the inflow paths 12 (12a, 12b) to circulate the air through the air conditioning devices 20 (20a, 20b). By executing such a dehumidification mode, the air from the vehicle interior or the vehicle exterior can be rapidly dehumidified.

### (B) Regeneration Mode

As shown in FIG. 4F, the regeneration mode regenerates the dehumidifying layer 80 by controlling the switching valves 14 (14a, 14b) in all branched paths 11 (11a, 11b) to allowing the air to flow out to the outflow paths 13 (13a, 13b) to circulate the air while heating the air conditioning devices 20 (20a, 20b). By executing such a regeneration mode, the moisture condensed on the air conditioning devices 20 (20a, 20b) can be evaporated by heating and discharged to the vehicle exterior, and mold and the like will be difficult to grow. Furthermore, when the air conditioning device 20 includes the dehumidifying layer 80, the moisture trapped in the dehumidifying layer 80 can be released, so that the dehumidifying layer 80 can be regenerated.

### (C) Dehumidification And Regeneration Mode

As shown in FIGS. 4B to 4E, the dehumidification and regeneration mode dehumidifies the air by controlling the switching valve 14 (14b) in a part of the branched paths 11 (11b) to allow the air to flow into the inflow path 12 (12b) to circulate the air through the air conditioning device 20 (20b), and regenerates the dehumidifying layer 80 by controlling the switching valve 14 (14a) in the remaining branched path 11 (11a) to allow the air to flow out to the outflow path 13 (13a) to circulate the air while heating the air conditioning device 20 (20a). By executing such a dehumidification and regeneration mode, it is possible to regenerate the air conditioning device 20 (20a) while dehumidifying the air from the vehicle interior or the vehicle exterior by the air conditioning device 20 (20b). Furthermore, by switching the air conditioning device 20 that performs dehumidification and regeneration at regular intervals, the dehumidification of the air from the vehicle interior or the vehicle exterior and the regeneration of the air conditioning device 20 can be continuously performed.

In the vehicle air conditioning system according to the embodiment of the present invention, the operation mode of the heat pump cycle 30 can include a cooling operation mode and a heating operation mode. Although the cooling operation mode is not particularly limited, it is preferable to cool the air conditioning device 20 by circulating the refrigerant expanded by the expansion valves 36b, 36c through the air conditioning device 20 to cool the air. Further, the heating operation mode is not particularly limited, but it is preferable to heat the air by compressing the refrigerant heat-exchanged with the outdoor heat exchanger 34 and the outflow path internal heat exchanger 35 by the compressor 33, and introducing the refrigerant discharged from the compressor 33 into the condenser 31. The operation mode of the heat pump cycle 30 can be selected depending on switch operations by the driver, temperature changes detected by various detection units, and the like.

Hereinafter, specific methods for the cooling operation mode and the heating operation mode will be described.

### (A) First Cooling Operation Mode

As shown in FIG. 4A, the first cooling operation mode opens the shutoff valves 37a, 37e to 37g and closes the shutoff valves 37b to 37d, thereby forming a flow path such that the refrigerant sequentially flows through the compressor 33, the outdoor heat exchanger 34, the expansion valves 36b, 36c, and the air conditioning devices 20. It should be noted that, in FIG. 4A, the flow path through which the refrigerant flows in this cooling operation mode is shown by a thicker line.

The refrigerant compressed by the compressor 33 to a high temperature and a high pressure is cooled by exchanging heat with the outside air and releasing the heat in the outdoor heat exchanger 34. The refrigerant leaving the outdoor heat exchanger 34 is pressure-reduced and expanded by the expansion valves 36b, 36c to form a low-temperature and low-pressure refrigerant, which enters the air conditioning devices 20a, 20b, and cools the air conditioning devices 20a, 20b. The cooled air conditioning devices 20a, 20b exchange heat with the air flowing through the air conditioning duct 10 to absorb the heat and cool the air. The refrigerant leaving the air conditioning devices 20a, 20b returns to the compressor 33.

When the cooling operation mode is performed, the air flowing through the air conditioning duct 10 is cooled by the air conditioning devices 20a, 20b, and the cooled air flows into the vehicle interior. The cooling operation mode is particularly useful when it is desired to rapidly cool the vehicle interior (strong cooling operation mode).

The cooling operation mode can be performed when the operation mode of the air conditioning devices 20 (20a, 20b) is the dehumidification mode.

### (B) Second Cooling Operation Mode

As shown in FIG. 4B, the second cooling operation mode opens the shutoff valves 37a, 37e, 37g and closes the shutoff valves 37b to 37d, 37f, thereby forming a flow path such that the refrigerant sequentially flows through the compressor 33, the outdoor heat exchanger 34, the expansion valve 36c, and the air conditioning devices 20. It should be noted that, in FIG. 4B, the flow path through which the refrigerant flows in this cooling operation mode is shown by a thicker line.

The refrigerant compressed by the compressor 33 to a high temperature and a high pressure is cooled by exchanging heat with the outside air and releasing the heat in the outdoor heat exchanger 34. The refrigerant leaving the outdoor heat exchanger 34 is pressure-reduced and expanded by the expansion valve 36c to form a low-temperature, low-pressure refrigerant, which enters the air conditioning device 20b, and cools the air conditioning device 20b. The cooled air conditioning device 20b exchanges heat with the air flowing through the air conditioning duct 10 to absorb the heat and cool the air. The refrigerant leaving the air conditioning device 20b returns to the compressor 33.

When the cooling operation mode is performed, the air flowing through the air conditioning duct 10 is cooled by the air conditioning device 20b, and the cooled air flows into the vehicle interior. The cooling operation mode is particularly useful when it is desired to rapidly cool the vehicle interior (strong cooling operation mode).

The cooling operation mode can be performed when the operation mode of the air conditioning devices 20 (20a, 20b) is the dehumidification and regeneration mode.

### (C) Third Cooling Operation Mode

As shown in FIG. 4C, the third cooling operation mode opens the shutoff valves 37a, 37c, 37g and closes the shutoff valves 37b, 37d to 37f, thereby forming a flow path such that the refrigerant sequentially flows through the compressor 33, the condenser 31, the expansion valve 36a, the outdoor heat exchanger 34, the expansion valve 36c, and the air conditioning devices 20. It should be noted that, in FIG. 4C, the flow path through which the refrigerant flows in this cooling operation mode is shown by a thicker line.

The condenser 31 and the expansion valve 36a are further disposed on a downstream side of the compressor 33 in the refrigerant flow path in this cooling operation mode. In the cooling operation mode, the cooling of the air by the air conditioning devices 20 and the heating of the air by the condenser 31 can be adjusted by controlling the opening degree of the air mix door 70, so that the temperature of the air can be controlled to the optimum temperature.

### (D) First Heating Operation Mode

As shown in FIG. 4D, the first heating operation mode opens the shutoff valves 37a to 37c and closes the shutoff valves 37d to 37g, thereby forming a flow path such that the refrigerant sequentially flows through the compressor 33, the condenser 31, the expansion valve 36a, and the outdoor heat exchanger 34. It should be noted that, in FIG. 4D, the flow path through which the refrigerant flows in this heating operation mode is shown by a thicker line.

The refrigerant compressed by the compressor 33 enters the condenser 31 as a high-temperature, high-pressure refrigerant, exchanges heat with the air flowing in the air conditioning duct 10, and releases the heat. The refrigerant leaving the condenser 31 is pressure-reduced and expanded by the expansion valve 36a to form a low-temperature, low-pressure refrigerant, and then exchanges the heat with the outside air in the outdoor heat exchanger 34 to absorb the heat, and returns to the compressor 33.

When this heating operation mode is performed, the air flowing through the air conditioning duct 10 is heated by the condenser 31, and the heated air flows into the vehicle interior. The temperature of the air flowing into the vehicle interior can be adjusted by controlling the opening degree of the air mix door 70.

This heating operation mode can be performed when the operation mode of the air conditioning devices 20 (20a, 20b) is the dehumidification mode or the dehumidification and regeneration mode, but it is particularly preferably performed when the operation mode is the dehumidification mode.

### (E) Second Heating Operation Mode

As shown in FIG. 4E, the second heating operation mode opens the shutoff valves 37b to 37d and closes the shutoff valves 37a, 37e to 37g, thereby forming a flow path such that the refrigerant sequentially flows through the compressor 33, the condenser 31, the expansion valve 36a, the outdoor heat exchanger 34 and the flow path internal heat exchanger 35. It should be noted that, in FIG. 4E, the flow path through which the refrigerant flows in this heating operation mode is shown by a thicker line.

In the refrigerant flow path in this heating operation mode, the outflow path internal heat exchanger 35 is further disposed on a downstream side of the outdoor heat exchanger 34. In this heating operation mode, the refrigerant that has undergone heat exchange with the outdoor heat exchanger 34 and the outflow path internal heat exchanger 35 is compressed by the compressor 33, and the refrigerant discharged from the compressor 33 is introduced into the condenser 31 to heat the air. Since the air heated when regenerating the air conditioning device 20 (20a) flows through the outflow path 13 (13a), the power consumption (compression percentage) of the compressor 33 can be reduced by exchanging the heat between the heated air and the refrigerant. In this heating operation mode, the temperature of the air flowing into the vehicle interior can also be adjusted by controlling the opening degree of the air mix door 70.

This heating operation mode can be performed when the operation mode of the air conditioning devices 20 (20a, 20b) is the dehumidification and regeneration mode.

The vehicle air conditioning system further includes a detection portion (not shown) capable of detecting fogging of the glass in the vehicle interior, and it is preferable that the control unit 40 executes the dehumidification and regeneration mode when the fogging of the glass in the vehicle interior is detected, and executes the dehumidification mode when the fogging of the glass in the vehicle is not detected. Such a control allows the regeneration of the air conditioning device 20 to proceed efficiently, while suppressing the fogging of the glass in the vehicle interior.

The detection portion capable of detecting the fogging of the glass in the vehicle interior is not particularly limited, but it is preferable to detect the fogging of the glass in the vehicle interior based on the temperature and humidity in the vehicle interior. The detection portion having such a function can stably detect the fogging of the glass.

When the air conditioning device 20 is provided with the dehumidifying layer 80, in the regeneration mode of the dehumidifying layer 80, the dehumidifying layer 80 is preferably heated to a temperature higher than the desorption temperature depending on the type of the dehumidifying material in order to promote the release of the moisture captured in the dehumidifying layer 80. For example, the dehumidifying layer 80 is preferably heated to 70 to 150° C., and more preferably 80 to 140° C., and even more preferably heated to 90 to 130° C.

From the viewpoint of stably performing the above control, it is desirable that the air conditioning device 20 be placed at a position close to the vehicle interior. Therefore, from the viewpoint of preventing electric shock and the like, it is preferable that the driving voltage of the air conditioning device 20 is 60V or less. Since the honeycomb structure 25 used in the air conditioning device 20 has a low electrical resistance at room temperature, the honeycomb structure 25 can be heated at the low driving voltage. It should be noted that the lower limit of the driving voltage is not particularly limited, but it may preferably be 10 V or more. If the driving voltage is less than 10V, the current during heating the honeycomb structure 25 becomes large, so that the conductor wire should be thick.

### DESCRIPTION OF REFERENCE NUMERALS

10 air conditioning duct
11, 11a, 11b branched path
12, 12a, 12b inflow path
13, 13a, 13b outflow path
14, 14a, 14b switching valve
20 air conditioning device
21 outer peripheral wall
22a first end face
22b second end face
23 cell
24 partition wall
25 honeycomb structure
26 cooling member
26a feed port
26b discharge port
26R flow path
27 insulating layer
28a, 28b pair of electrodes
29 terminal
30 heat pump cycle
31 condenser
33 compressor
34 outdoor heat exchanger
35 outflow path internal heat exchanger
36a-36c expansion valve
37a-37g shutoff valve
40 control unit
50 power source
60 ventilation fan
70 air mix door
80 dehumidifying layer

1. A vehicle air conditioning system, comprising:
an air conditioning duct for allowing air from a vehicle interior to flow therethrough; and
an air conditioning device disposed within the air conditioning duct,
wherein the air conditioning device comprises: a honeycomb structure having an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; and a cooling member disposed over the outer peripheral wall of the honeycomb structure, the cooling member forming a flow path between the honeycomb structure and the cooling member, the flow path allowing a refrigerant to flow therethrough.

2. The vehicle air conditioning system according to claim 1, wherein the air conditioning device further comprises a dehumidifying layer formed on each surface of the partition walls.

3. The vehicle air conditioning system according to claim 1, wherein the flow path for allowing the refrigerant to flow is connected to a heat pump cycle.

4. The vehicle air conditioning system according to claim 3, further comprising a control unit for controlling the air conditioning device and the heat pump cycle in response to an operation mode.

5. The vehicle air conditioning system according to claim 3,
wherein the air conditioning duct has two or more branched paths,
wherein the air conditioning device is disposed in each of the two or more branched paths,
wherein each of the two or more branched paths comprises: an inflow path for allowing the air to flow into the vehicle interior on a downstream side of the air conditioning device; and an outflow path for allowing the air to flow out to a vehicle exterior, and each of the two or more branched paths comprises a switching valve capable of switching the flow of the air between the inflow path and the outflow path, and
wherein the heat pump cycle comprises a condenser for performing heat exchange between heat of the refrigerant and the air in the air conditioning duct connected to the vehicle interior on the downstream side of the air conditioning device.

6. The vehicle air conditioning system according to claim 5, wherein the operation mode of the air conditioning device comprises:
a dehumidification mode wherein the air is dehumidified by controlling the switching valves in all of the branched paths to allow the air to flow into the inflow path to circulate the air through the air conditioning device; and
a dehumidification and regeneration mode wherein the air is dehumidified by controlling the switching valve in a part of the branched paths to allow the air to flow into the inflow path to circulate the air through the air conditioning device, and the humidified layer is regenerated by controlling the switching valve in the remaining branched paths to allow the air to flow out to the outflow path to circulate the air through the air conditioning device while heating the air conditioning device.

7. The vehicle air conditioning system according to claim 5, wherein the heat pump cycle further comprises:
a compressor for compressing and discharging the refrigerant;
an outdoor heat exchanger for exchanging heat between the refrigerant and outside air;
at least one expansion valve for expanding the refrigerant;
an outflow path internal heat exchanger for exchanging heat between the refrigerant and the heated air flowing through the outflow path;
wherein the operation mode of the heat pump cycle comprises:
a cooling operation mode wherein the air conditioning device is cooled to cool the air by allowing the refrigerant expanded by the expansion valve to flow through the air conditioning device; and
a heating operation mode wherein the refrigerant that has undergone heat exchange in the outdoor heat exchanger and the outflow path internal heat exchanger is compressed by the compressor, and the refrigerant discharged from the compressor is introduced into the condenser to heat the air.

8. The vehicle air conditioning system according to claim 1, wherein the material having the PTC property comprises barium titanate as a main component.

9. The vehicle air conditioning system according to claim 1, wherein the dehumidifying layer further comprises an adsorbent having a function of adsorbing at least one selected from carbon dioxide and volatile components, and/or a catalyst.

10. The vehicle air conditioning system according to claim 6, further comprising a detection portion capable of detecting fogging of glass in the vehicle interior, wherein the control unit executes the regeneration and regeneration mode when the fogging of the glass is detected, and the control unit executes the dehumidification mode when the fogging of the glass is not detected.

11. The vehicle air conditioning system according to claim 10, wherein the detection portion detects the fogging of the glass based on a temperature and a humidity in the vehicle interior.
